(19) United States
(12) Patent Application Publication
(10) Pub. No.: US 2011/0213914 A1
(43) Pub. Date: Sep. 1, 2011

(54) I-PEN

(76) Inventor: Fernando de Léon, Montevideo (UY)

(21) Appl. No.: 12/979,146

(22) Filed: Dec. 27, 2010

(30) Foreign Application Priority Data
Dec. 28, 2009 (UY) 004313

(51) Int. Cl. G06F 12/00

(52) U.S. Cl. 711/103; 711/E12.008

(57) ABSTRACT

This patent consists of a USB flash drive that includes two USB connectors at the ends of the main body that perform different functions. This storage device also includes an LCD display, headphone jack, and internal or removable battery.

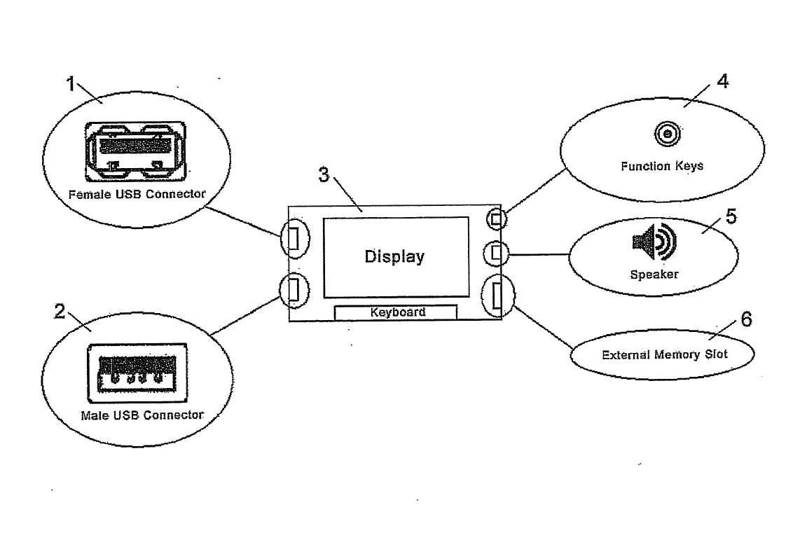

This utility model patent belongs to the field of the processing, transmission and storage of information that so far was possible by using a pendrive, among other media. This patent application offers an alternative to this, at the time that explores a new and simple way to manage information.

The I-PEN consists of an electronic Universal Serial Bus (USB) storage device, also called “USB flash drive” or “pendrive”, which allows the processing and mass storage of information in electronic storage units called files, which may be of different sizes. The processing of the information may be done from a computer, from the device itself or from another FLASH storage drive. The utility model of the I-PEN has a male USB connector and a female USB connector, which allow the transfer of information between two pendrives regardless of the use of a computer. Finally, in the patent application there appears an LCD, LED or similar display that enable the user to see and locate the different text files stored in the electronic USB flash drive or pendrive, among other functions detailed below.

In the current state of the art, regarding the transmission, processing and storage of information of any kind, no device was found that contains all the features mentioned in this opportunity. This arises from the research carried out in the Uruguayan National Direction of Industrial Property (Dirección Nacional de la Propiedad Industrial). Regardless of this fact, we are aware that both in the technological field as well as in the processing, storage and transmission or communication of information the advances are constant and there is an ongoing evolution.

We have sought advice from engineers with expertise in the area, as well as from importers and distributors of similar products, and nothing appeared to be similar to this model that features in a single product a male USB, a female USB and a LCD or similar display.

As of today, in the current state of the art and therefore in the national and international market, there are hundreds of devices based on a storage unit to which the user can access through an interface for human use. These devices are capable of storing great quantities of files of different kinds for its transmission or direct use. We know there are some devices of this kind that are capable of directly playing audio files as well as some others capable of directly playing video files, images and text, always incorporating a built-in display (LCD, LED or similar).

Such devices usually get connected to computers using the USB (Universal Serial Bus) protocol in order to exchange files. This is the only possible way to send or receive information, that is, from a USB connector to a computer or from a computer to a USB connector.

The advance proposed by the device described in this utility model application consists of including a female USB in addition to the male USB (which is usual in most storage devices). The inclusion of this female USB connector allows sending and receiving information and any kind of data to and from other storage devices without the need of using a computer. The inclusion of this feature in the storage devices enables the independence from computers to a great extent, which represents an important advantage over the existing storage devices. To apply this advance, it is necessary that the device that gets connected to the model presented in this opportunity has a male USB connector.

At present, common USD devices on the market can only transfer or receive information to or from a computer. This condition severely restricts the use of the pendrive that can not exchange information if it is not in the same place the computer is. The product presented in this utility model patent overcomes this problem as it incorporates a female USB connector 1 that enables the exchange with other devices that contain an electronic USB FLASH drive without the need of using a computer.

The product presented in this opportunity has other additional advantages.

It also includes the transfer of files to and from other devices through Bluetooth and Infrared technology, provided that the other devices allow doing that.

In addition, it displays multimedia features, enabling to play audio and video files, outputting the audio through headphones or a built-in speaker, and playing videos through a built-in LCD, LED or similar display 3. It is also possible to view stored text files through such display. The processing of multimedia files is performed by the different function keys 4 of the device: play, fast forward, rewind, stop, pause, etc. This kind of display usually appears in music players but it is not commonly incorporated in a pendrive so as to find the information and then transfer it to the desired USB connector.

Another advantage of the patent submitted is the Hold switch. Once the Hold switch is moved to the hold position all function keys are disabled and have no effect on the system.

The device includes the basic on/off function that is controlled by the ON/OFF switch.

It also enables audio output through a Frequency Modulation (FM) Modulator where the desired frequency can be selected. The user may tune it in a receiver device to hear the sound of the audio 5.

These devices may be powered by an internal battery or a removable one. These batteries may be charged directly—if they allow it—through the male USB connector 2 of the device, without the need of an external battery charger.

The storage capacity of these devices can be increased by inserting external memory cards such as micro SD or similar, through an external memory slot 6. USB flash drives implement the USB Mass Storage Device Class standard. It is by this standard that most operative systems are able to read and write in such storage devices without additional controllers.

Supported speeds are: USB 1.0/1.1 from 1.5 Mbps to 12 Mbps; USB 2.0 up to 480 Mbps; USB 3.0 up to 5 Gbps.

We believe this application meets the legal requirements provided by law in order to obtain the utility model patent. The I-PEN is a new product obtained from the introduction of a new conformation in a work instrument or device—specifically an electronic USB FLASH drive—that results in better use or better result for the function it is intended for. In addition, we believe this is a novel device for as it is not in the state of the art research. Finally, this product involves an input of minimal inventive activity.

The description of the patent submitted in this opportunity is not essential but we believe it is appropriate to show a clarifying figure for a better understanding of what is being discussed. This figure shows clearly and completely the device to be patented and facilitates its reproduction and manufacturing.

### BRIEF DESCRIPTION OF THE DRAWING

The figure is a chart of a USB Flash drive according to the subject invention .

Element one: Female USB connector

Element two: Male USB connector

Element three: LCD, LED or similar display of different sizes

Element four: Function keys: ON/OFF, Hold, Play, Rewind, Pause, etc.

Element five: External memory slot, i.e. SD card.

### Legal Grounds

Usually, utility model patents have been considered minor inventions as they meet less demanding conditions than invention patents. Roughly, the difference is that the utility model consists of a utilitarian invention introduced in already known objects, with an impact only in their shape. The other important difference is that the inventive idea of the utility model is smaller than that of the invention patent, as the first one comes from a pre-existing invention or creation. Not only does the I-PEN meet the requirements of the Uruguayan law for its holder to be granted a free use patent, but rather clearly exceeds such requirements. In relation to the contribution made to a particular object, it is clearly demonstrated both in the Specifications and in the Model Description that a specific novelty is added to a pre-existing and already known object. Regarding the minimum of inventive, we believe it exceeds this limit by offering an alternative that is so far unknown in our market.

In our country, the utility model consists of a new configuration for a utilitarian object in order to provide higher functionality. This new configuration provides the object with a functional improvement that differentiates it from the rest and grants an exclusive right on the patent use. The I-PEN would provide common pendrives with two USB connectors—a male one and a female one—thus enabling the improvement of their traditional functions.

The I-PEN has a defined configuration that although outwardly it is not that different from the rest of the pendrives, it differs inwardly as it has two USB connectors and a LCD, LED or similar display. In this way, it has a noticeable shape as required by law. Apart from that requirement, our law and doctrine requires that the utility model patent must have a defined shape in space and must be permanent. In addition, a cause-effect relation between the new shape and the functional improvement of the utilitarian object must be identified. The I-PEN also meets such requirements as demonstrated throughout this application, especially in the Specifications and in the Model Description.

The utility model concept is vested in Section 81 of the Patents Act, and maintains the characterization already known in our law that emphasizes the functionality.

We believe it is appropriate to add the above mentioned section: Any new disposition or conformation obtained or introduced in tools, work instruments, utensils, devices, equipment or other known objects that results in better use or function or presents an advantage in manufacturing shall be considered a patentable utility model.

A utility model shall be considered new if it does not form part of the state of the art.

In order to be patentable, the utility model requires a minimal inventive activity. The better use requirement in the utility model should not only be in relation to the application of the object, but also in relation to the better function or facilitation of the manufacturing process of the object. Although the manufacturing of the I-PEN is in an early stage, this will not be a major drawback and it will be easily manufactured by the one who obtains a license granted by Mr. Fernando de Leon.

First, the concept refers to a shape, a disposition or conformation applied to tools, work instruments, utensils, devices, equipment or other known objects. Second, the creation must result in better use or function or present an advantage in manufacturing. The law requires that the examiner assesses the shape innovation to be patented. When this instance comes, we will make available to the National Direction of Industrial Property the engineers who worked with us to submit this patent.

The utility model concept is complemented by the exclusions of subject matter from patentability set forth in Section 83 of the Patents Act.

The aforementioned section reads: The following subject matters shall not be protected by utility model patent applications:
a—Changes in the shape, dimensions, proportions or materials of an object, unless such changes modify its attributes or functions.
b—The mere replacement of some features by others already known and equivalent.
c—Procedures
d—The subject matter excluded from protection by invention patent pursuant to this Act

As noted, the I-PEN does not fall into any of these numerals so such patent is fully recordable and liable for exclusive rights.

Patentability requirements are supplemented by the reference to two common conditions with patents: novelty and inventive activity. They are mentioned respectively in the second and third paragraphs of Article 81 of the Act, so we consider that transcribing this article is not necessary.

The novelty is defined as for the invention patent, negatively, by the lack of inclusion of the subject matter of the patent application in the state of the art. It is noteworthy that the novelty shall not be related to the objective pursued by the change in the shape nor shall it be related to the shape itself applied to the utilitarian object: it is the modified shape of an already known object that shall be novel.

The concept of inventive activity, however, has differences from patents. In the utility model this requirement is minimal, even though the initial main idea is the same.

As explained above, the utility model patent application submitted in this opportunity (I-PEN) fully meets these requirements.

Article 82 vests the unity of the object: We believe it is useful to include it: The utility model application may only refer to an object, notwithstanding that it may include two or more parts that function as a single set. Several features or aspects of such object may be claimed in the same application.

In this way, in terms of utility model, only the creation applied to a single object may be submitted. Notwithstanding this, two or more parts that constitute a protected creation may be claimed. The I-PEN also meet this requirement as the novelty is applied to a particular object.

1-2. (canceled)

3. A pendrive comprising an electronic flash memory data storage device and including a male USB connector and a female USB connector, each being at the end of a main body.

4. The pendrive of claim 3 including a LCD, LED or other display of a size to conform to the pendrive.
